(19) United States
(12) Patent Application Publication
(10) Pub. No.: US 2006/0122352 A1
(43) Pub. Date: Jun. 8, 2006

(54) Polyurethane composition containing polyaldimine

(75) Inventor: Urs Burckhardt, Zurich (CH)

Correspondence Address: OLIFF & BERRIDGE, PLC, P.O. BOX 19928, ALEXANDRIA, VA, 22320, US

(73) Assignee: SIKA TECHNOLOGY AG, Baar (CH)

(21) Appl. No.: 10/522,412

(22) PCT Filed: Jul. 23, 2003
(86) PCT No.: PCT/EP03/08083

§ 371 Date: Jan. 24, 2006

(30) Foreign Application Priority Data
Jul. 26, 2002 (EP) 02016755.7

(51) Int. Cl. C08G 18/00

(52) U.S. Cl. 528/44

(57) ABSTRACT

The invention relates to compositions containing at least one polyurethane prepolymer A which has isocyanate end groups and is produced from at least one polyisocyanate and at least on polyol, and at least one polyaldimine B which can be obtained from at least one polyamine C having aliphatic primary amino groups and at least one aldehyde D. The invention also relates to the production of said compositions, and to the production of the polyaldimine. Disclosed is also the use of said compositions as an adhesive, a sealant, a coating or a lining. The invention further relates to methods for gluing, sealing or coating, and to articles having a surface which has been at least partially brought into contact with one such composition. Said compositions have a significant advantage in that they are odourless before during and after the hardening thereof.

### TECHNICAL FIELD AND PRIOR ART

The invention relates to polyurethane compositions comprising at least one polyurethane prepolymer and at least one polyaldimine which cure without nuisance odor. The polyaldimine used for this purpose is obtainable from a polyamine having aliphatic primary amino groups (frequently referred to in the subsequent text as “aliphatic polyamine”) and a specific aldehyde.

Polyurethanes are used among other things as one-component, moisture-curing, elastic sealants, adhesives and coatings. Customarily they comprise a polyurethane prepolymer which contains isocyanate groups, is prepared from polyols and polyisocyanates, is subsequently combined with further components and is stored in the absence of moisture up until its use. These systems, which are known per se, have the disadvantage that the CO₂ gas formed when the isocyanate groups react with water can lead to bubbles in the cured product.

Polyaldimines are compounds known in polyurethane chemistry as curing agents, described for example in U.S. Pat. No. 3,420,800 and U.S. Pat. No. 3,567,692. Polyaldimines is a designation given to molecules which have two or more aldimine groups R—CH═N—R′. From polyaldimines and polyurethane prepolymers containing isocyanate groups it is possible to formulate one-component products having good mechanical service properties, which are sufficiently stable on storage and cure rapidly on contact with water or moisture from the air. The polyaldimines hydrolyze with water to the corresponding aldehydes and polyamines, whereupon the latter react with the isocyanate groups of the polyurethane prepolymer and cure it without the liberation of CO₂ and hence without the formation of bubbles.

Polyaldimines of aliphatic polyamines and their application as curing agents for polyurethanes are very well known. They are described for example in U.S. Pat. No. 3,932,357.

It is customary to use polyaldimines of relatively volatile aldehydes, which are known to have a particularly intense odor. When they are employed, therefore, effective ventilation or respiratory protection is necessary, particularly if organic solvents are used additionally. For applications involving predominantly solvent-free products of high viscosity in thick films, as is the case, for example, with elastic seals and bonds, the odor of the aldehyde that is released during the hydrolysis of the polyaldimines is a particular nuisance, since it remains for a relatively long period of time. This is a result of the fact that, on the one hand, the complete curing of a moisture-curing polyurethane composition applied in a thick film takes a relatively long time, since the inward diffusion of the water required for curing through the material that has already cured becomes increasingly slower; and that, on the other hand, the aldehyde released in the curing reaction diffuses ever more slowly outward through the increasingly thick layers of the cured material. The odor burden caused by the escape of the aldehyde after the product has cured is tolerated in part for certain applications, such as in the exterior of buildings, for example. Since, however, the intensive aldehyde odor can lead to headaches and nausea, there is an increasing desire even in these areas of application for odorless systems. To the skilled worker it is clear that the term “odorless” is difficult to define. Here and throughout the document it should be understood to mean “imperceptible or only slightly perceptible (smellable) by a human being possessing the sense of smell”.

In other, so-called odor-sensitive applications, in contrast, such odor burdens are fundamentally not tolerated. Particularly odor-sensitive applications are those in enclosed areas, such as the sealing of joints in the interior of buildings or the bonding of components in the interior of vehicles, for example. Odorlessness here is a mandatory condition, even during and shortly after the application of a product. For applications in the interior of vehicles, strict standards are generally applied with respect to volatile substances which escape from, for example, an adhesive. Thus within the automobile industry there are corresponding limits laid down for the volatile components which escape from an adhesive, referred to as “fogging” (measurement method: see, e.g., DIN 75201).

To date there have been a variety of attempts at reducing the odor of aldimine-containing systems.

U.S. Pat. No. 4,469,831 describes a moisture-curing, one-component polyurethane composition comprising 2,2-dimethyl-3-(isobutyroxy)propanaldimines of aliphatic polyamines. This composition has a good stability on storage and a high cure rate and, purportedly, little odor. The use of the polyaldimines described, however, gives rise to a long-lasting, pungent odor which is intolerable for odor-sensitive applications.

U.S. Pat. No. 4,853,454 describes, among other things, a similar moisture-curing, one-component polyurethane composition which comprises substituted 2,2-dimethylpropanealdimines of aliphatic polyamines. The aldehydes that are released during the hydrolysis of the polyaldimines described are said on account of their high vapor pressure to lead to compositions which are purportedly of very low odor. When the polyaldimines described are used, however, there are unpleasant odors, perceptible for a long time, in this case as well, which renders these substances unsuitable for odor-sensitive applications.

U.S. Pat. No. 4,720,535 describes moisture-curing one-component polyurethane compositions comprising substituted 2,2-dimethylpropanealdimines of aromatic polyamines. The use of the polyaldimines described is unsuitable owing to the aromatic polyamines used. On the one hand, aromatic polyamines are generally much more toxic than their aliphatic counterparts, and on the other hand polyaldimines of aromatic polyamines, as curing agents, are much less reactive than those of aliphatic polyamines, both in respect of the hydrolysis of the aldimine groups and also, mostly, in respect of the reaction of the amino groups with the isocyanate groups of the polyurethane prepolymer. Moreover, the majority of the aldehydes described likewise give rise to an odor ranging from markedly perceptible to strong.

U.S. Pat. No. 6,136,942 describes a one-component polyurethane composition which comprises 3-phenyloxybenzaldimines of aliphatic polyamines or similar compounds and is said to cure with low odor. The odor of the aromatic aldehydes that are released when these polyaldimines are used, however, is markedly perceptible and is likewise intolerable for odor-sensitive applications. Moreover, the presence of 3-phenyloxybenzaldehyde and similar aromatic aldehydes may have a disruptive consequence for the light stability of the cured polyurethane composition.

With the prior art is had not been possible to date to utilize the advantages of moisture-curing, one-component polyurethane compositions comprising polyaldimines of aliphatic polyamines, such as absence of bubbling during cure, high cure rate, and good mechanical properties after curing, for odor-sensitive applications.

Problem and Solution

The problem addressed by the present invention was to provide moisture-curing one-component polyurethane compositions which comprise as curing agent at least one polyaldimine of aliphatic polyamines, cure without nuisance odor and are therefore suitable, among other things, for odor-sensitive applications, such as the sealing of joints in the interior of buildings or the bonding of components in the interior of vehicles, for example. A suitable composition must on the one hand be readily preparable from commercially available raw materials, must have an adequate stability on storage and must cure with sufficient rapidity after application. The aldehyde released when the polyaldimine is hydrolyzed must not give rise to nuisance odor or have any deleterious consequences for the cured polyurethane composition.

Surprisingly it has been found that the conditions specified above are very well met by a composition comprising at least one polyurethane prepolymer having isocyanate end groups and at least one polyaldimine which is obtainable from at least one polyamine having aliphatic primary amino groups and at least one aldehyde according to the formula specified later on.

The preparation of the aldehydes used for the polyaldimines starts from readily available, inexpensive raw materials and is accomplished with surprising simplicity by the esterification of carboxylic acids of low volatility, examples being long-chain fatty acids, with β-hydroxy aldehydes, especially 3-hydroxypivalaldehyde. The resulting aldehydes are solid or liquid at room temperature, depending on the carboxylic acid used. They can be subsequently reacted with polyamines directly to the corresponding poly-aldimines. The required reaction steps can all be carried out without the use of solvents, so that no solvent residues enter the composition, where they could give rise to nuisance odor and fogging. Since the carboxylic acids used in the preparation of the aldehydes are themselves of low odor, traces thereof likewise cause no nuisance odor, which makes it unnecessary to carry out costly and inconvenient purification of the polyaldimines prior to their use.

A fact surprising and not obvious for the skilled worker is that polyaldimines of this kind possess sufficiently high reactivity to be used as curing agents for polyurethanes. The skilled worker would have expected that, on account of their hydrophobic structure, they would be poorly accessible to the water needed for the hydrolysis of the aldimine groups, and that consequently their hydrolysis would proceed only slowly and incompletely. Against expectation, however, the polyaldimines described react quickly and completely with moisture in the polyurethane composition. Their reactivity is comparable with that of substantially less hydrophobic polyaldimines, as described for example in U.S. Pat. No. 4,469,831.

The polyurethane compositions of the invention have outstanding stability on storage. On contact with moisture they cure very rapidly without producing a nuisance odor. The aldehyde released remains in the cured polyurethane composition, where it has no deleterious consequences for the properties of said composition. Its hydrophobicity, on the contrary, leads to an entirely desired increase in the stability of the cured polyurethane composition to hydrolysis.

### SUMMARY OF THE INVENTION

The present invention relates to compositions comprising at least one polyurethane prepolymer A having isocyanate end groups, which is prepared from at least one polyisocyanate and at least one polyol, and at least one polyaldimine B, which is obtainable from at least one polyamine C having aliphatic primary amino groups and at least one aldehyde D.

Also disclosed is the preparation of these compositions, and also the preparation of the polyaldimine.

In addition the use is described of these compositions as adhesive, sealant, coating or covering. Also provided are methods of adhesive bonding, sealing or coating. Finally there is a description of articles whose surface has been at least partly contacted with such a composition.

### DETAILED DESCRIPTION OF THE INVENTION

The present invention relates to compositions comprising at least one polyurethane prepolymer A having isocyanate end groups which is prepared from at least one polyisocyanate and at least one polyol, and at least one polyaldimine B which is obtainable from at least one polyamine C having aliphatic primary amino groups and at least one aldehyde D having the formula (I):

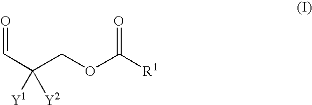

where Y¹ and Y² on the one hand independently of one another are an alkyl, aryl or arylalkyl group, which if desired may in each case be substituted, if desired may in each case contain heteroatoms and if desired may in each case contain unsaturated components. Preferably Y¹=Y²=methyl.

On the other hand Y¹ and Y² can be connected to one another to form a carbocyclic or heterocyclic ring which has a ring size of between 5 and 8, preferably 6, atoms and if desired has one or two singly unsaturated bonds.

The radical R¹ stands either for a linear or branched alkyl chain having 11 to 30 carbon atoms, if desired having at least one heteroatom, in particular having at least one ether oxygen, or for a singly or multiply unsaturated linear or branched hydrocarbon chain having 11 to 30 carbon atoms, or for a radical of the formula (II) or (III).

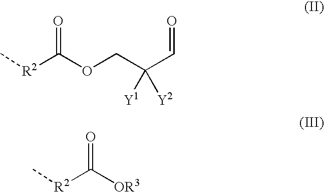

In the formulae (II) and/or (III) R² stands for a linear or branched or cyclic alkylene chain having 2 to 16 carbon atoms, if desired having at least one heteroatom, in particular having at least one ether oxygen, or for a singly or multiply unsaturated linear or branched or cyclic hydrocarbon chain having 2 to 16 carbon atoms, and R³ is a linear or branched alkyl chain having 1 to 8 carbon atoms. Y¹ and Y² have the definition already specified, and the dashed lines in the formulae denote the connection points.

By “poly” in “polyaldimine”, “polyol”, “polyisocyanate”, and “polyamine” are meant molecules which formally comprise two or more of the functional groups in question.

The term “polyamines having aliphatic primary amino groups” refers in the present document always to compounds which formally comprise two or more NH₂ groups which are attached to an aliphatic, cycloaliphatic or arylaliphatic radical. They consequently differ from the aromatic amines, in which the amino groups are attached directly to an aromatic radical, such as in aniline or 2-aminopyridine, for example.

The polyurethane prepolymer A is prepared from at least one polyisocyanate and at least one polyol. This reaction may take place by the polyol and the polyisocyanate being brought to reaction by customary methods, at temperatures for example of 50 to 100° C., with or without the use of suitable catalysts, the polyisocyanate being metered such that its isocyanate groups are in a stoichiometric excess in relation to the hydroxyl groups of the polyol. The excess of polyisocyanate is chosen so that in the resulting polyurethane prepolymer A after the reaction of all the hydroxyl groups of the polyol there remains a free isocyanate group content of 0.1% to 15% by weight, preferably 0.5% to 5% by weight, based on the polyurethane prepolymer A as a whole. If desired the polyurethane prepolymer A can be prepared with the use of solvents or plasticizers, with the solvents or plasticizers used containing no isocyanate-reactive groups.

As polyols for preparing the polyurethane prepolymer A it is possible, for example, to use the following commercially customary polyols or any desired mixtures thereof:

polyoxyalkylene polyols, also called polyether polyols, which are polymerization products of ethylene oxide, 1,2-propylene oxide, 1,2- or 2,3-butylene oxide, tetrahydrofuran or mixtures thereof, optionally polymerized by means of a starter molecule having two or more active hydrogen atoms, such as water, ammonia or compounds having two or more OH or NH groups for example, such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline and mixtures of the aforementioned compounds. Use may be made both of polyoxyalkylene polyols which have a low degree of unsaturation (measured in accordance with ASTM D-2849-69 and stated in milliequivalent of unsaturation per gram of polyol (meq/g)), prepared for example with the aid of what are known as double metal cyanide complex catalysts (DMC catalysts), and of polyoxyalkylene polyols having a higher degree of unsaturation, prepared for example by means of anionic catalysts such as NaOH, KOH or alkali metal alkoxides.

Particular suitability is possessed by polyoxyalkylenediols or polyoxyalkylenetriols, especially polyoxypropylenediols or polyoxypropylenetriols.

Of especial suitability are polyoxyalkylenediols or polyoxyalkylenetriols having a degree of unsaturation of 0.02 meq/g and having a molecular weight in the range from 1000 to 30 000 g/mol, and also polyoxypropylenediols and -triols having a molecular weight of 400 to 8000 g/mol. By “molecular weight” or “molar weight” is meant in the present document always the molecular weight average Mₙ.

Likewise of particularly suitability are so-called EO endcapped (ethylene oxide-endcapped) polyoxypropylenediols or -triols. The latter are special polyoxypropylene-polyoxyethylene polyols, which are obtained, for example, by alkoxylating pure polyoxypropylene polyols with ethylene oxide after the end of the polypropoxylation, and which as a result contain primary hydroxyl groups.

Hydroxy-functional polybutadienes.

Polyester polyols, prepared for example from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid or mixtures of the aforementioned acids, and also polyester polyols formed from lactones such as, for example, ε-caprolactone.

Polycarbonate polyols, such as are obtainable by reacting, for example, the abovementioned alcohols—used for the synthesis of the polyester polyols—with dialkyl carbonates, diaryl carbonates or phosgene,

Polyacrylate and polymethacrylate polyols.

These stated polyols have an average molecular weight of 250 to 30 000 g/mol and an average OH functionality in the range from 1.6 to 3.

In addition to these stated polyols it is possible to use dihydric or polyhydric alcohols of low molecular weight, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols and other polyfunctional alcohols, low molecular weight alkoxylation products of the aforementioned dihydric and polyhydric alcohols, and mixtures of the aforementioned alcohols, in the preparation of the polyurethane prepolymer A.

The polyurethane prepolymer A is prepared using commercially customary polyisocyanates. Examples that may be mentioned include the following polyisocyanates, which are very well known within polyurethane chemistry:

2,4- and 2,6-tolylene diisocyanate (TDI) and any desired mixtures of these isomers, 4,4′-diphenylmethane diisocyanate (MDI), the positionally isomeric diphenylmethane diisocyanates, 1,3- and 1,4-phenylene diisocyanate, 2,3,5,6-tetramethyl-1,4-diisocyanatobenzene, 1,6-hexamethylene diisocyanate (HDI), 2-methylpentamethylene 1,5-diisocyanate, 2,2,4- and 2,4,4-trimethyl-1,6-hexamethylene diisocyanate (TMDI), dodecamethylene 1,12-diisocyanate, cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydro-2,4′- and 4,4′-diphenylmethane diisocyanate (HMDI), 1,4-diisocyanato-2,2,6-trimethylcyclohexane (TMCDI), m- and p-xylylene diisocyanate (XDI), tetramethylxylylene 1,3- and 1,4-diisocyanate (TMXDI), 1,3- and 1,4-bis(isocyanatomethyl)cyclohexane, and also oligomers and polymers of the aforementioned isocyanates, and also any desired mixtures of the aforementioned isocyanates. Particular preference is given to MDI, TDI, HDI and IPDI.

The polyaldimine B is preparable from at least one polyamine C having aliphatic primary amino groups and from at least one aldehyde D by means of a condensation reaction with elimination of water. Condensation reactions of this kind are very well known and are described for example in Houben-Weyl, “Methoden der organischen Chemie”, vol. XI/2, page 73 ff. The aldehyde D is employed in this reaction stoichiometrically or in a stoichiometric excess in relation to the primary amino groups of the polyamine C.

Suitable polyamines C having aliphatic primary amino groups for preparing the polyaldimine B are the polyamines which are known in polyurethane chemistry, such as are used, among other things, for two-component polyurethanes. Examples that may be mentioned include the following: aliphatic polyamines such as ethylenediamine, 1,2- and 1,3-propanediamine, 2-methyl-1,2-propanediamine, 2,2-dimethyl-1,3-propane-diamine, 1,3- and 1,4-butanediamine, 1,3- and 1,5-pentanediamine, 1,6-hexanediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecane-diamine, 1,12-dodecanediamine, methylbis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines such as 1,2-, 1,3- and 1,4-diaminocyclohexane, bis(4-aminocyclohexyl)methane, bis(4-amino-3-methylcyclohexyl)methane, bis(4-amino-3-ethylcyclohexyl)methane, bis-(4-amino-3,5-dimethylcyclohexyl)methane, 1-amino-3-aminomethyl-3,5,5-tri-methylcyclohexane (=isophoronediamine or IPDA), 2- and 4-methyl-1,3-diaminocyclohexane and mixtures thereof, 1,3- and 1,4-bis(aminomethyl)-cyclohexane, 1-cyclohexylamino-3-aminopropane, 2,5(2,6)-bis(aminomethyl)-bicyclo[2.2.1]heptane (NBDA, manufactured by Mitsui Chemicals), 3(4),8(9)-bis(aminomethyl)tricyclo[5.2.1.0^{2,6}]decane, 1,4-diamino-2,2,6-trimethylcyclo-hexane (TMCDA), 3,9-bis(3-aminopropyl)-2,4,8,10-tetraoxaspiro[5.5]undecane, 1,3- and 1,4-xylylenediamine, aliphatic polyamines containing ether groups such as bis(2-aminoethyl) ether, 4,7-dioxadecane-1,10-diamine, 4,9-dioxa-dodecane-1,12-diamine and higher oligomers thereof, polyoxyalkylene-polyamines having in theory two or three amino groups, obtainable for example under the name Jeffamine® (manufactured by Huntsman Chemicals), and also mixtures of the aforementioned polyamines.

Preferred polyamines are 1,6-hexamethylenediamine, MPMD, DAMP, 2,2,4- and 2,4,4-trimethylhexamethylenediamine, 4-aminomethyl-1,8-octane-diamine, IPDA, 1,3- and 1,4-xylylenediamine, 1,3- and 1,4-bis(aminomethyl)-cyclohexane, bis(4-aminocyclohexyl)methane, bis(4-amino-3-methylcyclohexyl)methane, 3(4),8(9)-bis(aminomethyl)tricyclo[5.2.1.0^{2,6}]decane, 1,2-, 1,3- and 1,4-diaminocyclohexane, polyoxyalkylene-polyamines having in theory two or three amino groups, especially Jeffamine® EDR-148, Jeffamine® D-230, Jeffamine® D400 and Jeffamine® T-403, and, in particular, mixtures of two or more of the aforementioned polyamines.

The polyaldimine B is prepared using at least one aldehyde D having the formula (I):

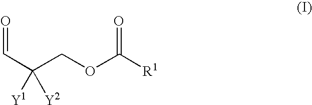

In one preferred preparation method of the aldehyde D the starting material is a β-hydroxy aldehyde of formula (IV), which can be prepared, for example, from formaldehyde (or paraformaldehyde or oligomeric forms of formaldehyde, such as 1,3,5-trioxane) and an aldehyde of formula (V) in a crossed aldol addition, where appropriate in situ.

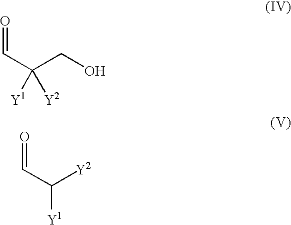

Y¹ and Y² in the formulae (IV) and (V) have the definition already described.

The β-hydroxy aldehyde of formula (IV) is reacted with a carboxylic acid to the corresponding ester, specifically either with a long-chain fatty acid R¹—COOH to the corresponding fatty acid ester; and/or with a dicarboxylic acid monoalkyl ester HOOC—R²—COOR³ to the aldehyde D having the radical according to formula (III); and/or with a dicarboxylic acid HOOC—R²—COOH to the aldehyde D, in this case a dialdehyde, having the radical according to formula (II). The formulae (II) and (III) and R¹, R² and R³ have the definition already described. This esterification can take place without the use of solvents in accordance with known methods, described for example in Houben-Weyl, “Methoden der organischen Chemie”, vol. VIII, pages 516-528.

Where dicarboxylic acids are used a mixture is obtained of the aldehydes D having the radicals according to formula (II) and according to formula (III), if, for example, some of the carboxylic acid groups are first esterified with the β-hydroxy aldehyde according to formula (IV), and subsequently the remaining carboxylic acid groups are esterified with an alkyl alcohol (R³—OH). A mixture of this kind can be further used directly for preparing the polyaldimine B.

Preferred aldehydes according to formula (V) for reaction with formaldehyde to give β-hydroxy aldehydes according to formula (IV) are the following: isobutyraldehyde, 2-methylbutyraldehyde, 2-ethylbutyraldehyde, 2-methylvaleraldehyde, 2-ethylcaproaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde and diphenylacetal-dehyde. Isobutyraldehyde is particularly preferred.

Preferred β-hydroxy aldehydes according to formula (IV) are the products from the reaction of formaldehyde with the aldehydes according to formula (V) specified before as being preferred. 3-Hydroxypivalaldehyde is particularly preferred.

As suitable carboxylic acids for esterification with the β-hydroxy aldehydes according to formula (IV) mention may be made, for example, of the following: lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, eleostearic acid, arachidonic acid, succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, hexahydro-terephthalic acid, 3,6,9-trioxaundecanedioic acid and similar derivatives of polyethylene glycol, dehydrogenated ricinoleic acids, and also fatty acids from the industrial saponification of natural oils and fats such as, for example, rapeseed oil, sunflower oil, linseed oil, olive oil, coconut oil, oil palm kernel oil and oil palm oil.

Preference is given to lauric acid, myristic acid, palmitic acid, stearic acid, oleic acid, linoleic acid, linolenic acid, succinic acid, adipic acid, azelaic acid and sebacic acid and to technical mixtures of fatty acids which comprise these acids.

The reaction of at least one polyamine C having aliphatic primary amino groups with at least one aldehyde D gives rise for example to polyaldimines of the schematic formulae (VI) and (VII),

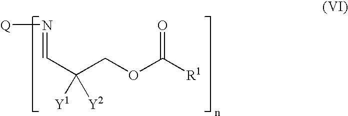

where n is 2, 3 or 4 and Q is intended to represent the radical of a polyamine C having aliphatic primary amino groups after the removal of all the primary amino groups; and

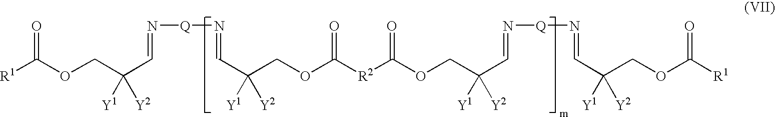

where m is an integer from 0 to 10 and Q in the same molecule is identical or different and is intended to represent in each case the radical of a polyamine C having aliphatic primary amino groups following the removal of all the primary amino groups. The radicals Y¹, Y², R¹ and R² in the formulae (VI) and (VII) have the definition already described.

If a dialdehyde D having the radical according to formula (II) is used for preparing a polyaldimine B then it is advantageously either used in a mixture with a monoaldehyde D, in a proportion such that average values for m in the range from 1 to 10 are obtained for the polyaldimine from formula (VII); or it is metered such that there is an excess of aldehyde groups in relation to the amino groups during the preparation of the polyaldimine B, the aldehyde excess being chosen so that likewise average values for m in the range from 1 to 10 are obtained for the polyaldimine from formula (VII). In both ways a mixture of oligomeric polyaldimines having a readily manageable viscosity is obtained.

As polyaldimine B it is also possible to use mixtures of different polyaldimines, including in particular mixtures of different polyaldimines prepared with the aid of different polyamines C having primary aliphatic amino groups, reacted with different or the same aldehydes D, including in particular mixtures of polyaldimines prepared with the aid of polyamines having different numbers of primary aliphatic amino groups, i.e. different values of n.

The polyurethane prepolymer A and the polyaldimine B are combined with one another, the polyaldimine B being metered in an amount of 0.1 to 1.1 equivalents of aldimine groups per equivalent of isocyanate groups in the polyurethane prepolymer A. Additionally it is possible to add a catalyst for the hydrolysis of the polyaldimine, an example being an organic carboxylic acid such as benzoic acid or salicylic acid, an organic carboxylic anhydride such as phthalic anhydride or hexahydrophthalic anhydride, a silyl ester of organic carboxylic acids, an organic sulfonic acid such as p-toluenesulfonic acid, or another organic or inorganic acid, or mixtures of the aforementioned acids.

Additional components that may be present in the polyurethane compositions described include the following auxiliaries and additives well known within the polyurethane industry:

plasticizers, examples being esters of organic carboxylic acids or their anhydrides, phthalates, such as dioctyl phthalate or diisodecyl phthalate, adipates, such as dioctyl adipate, sebacates, organic phosphoric and sulfonic esters, polybutenes, and other, non-isocyanate-reactive compounds, for example; solvents; organic and inorganic fillers, such as ground or precipitated calcium carbonates, are coated with stearates if desired, carbon blacks, kaolins, aluminum oxides, silicas and PVC powders, for example; fibers, of polyethylene for example; pigments; catalysts such as, for example, organotin compounds such as dibutyltin dilaurate or dibutyltin diacetylacetonate, or other catalysts customary in polyurethane chemistry for the reaction of isocyanate groups; rheology modifiers such as thickeners, for example, examples being urea compounds, polyamide waxes, bentonites or pyrogenic silicas; adhesion promoters, especially silanes such as epoxysilanes, vinylsilanes, isocyanato-silanes, and aminosilanes reactive with aldehydes to form aldiminosilanes; drying agents, such as p-tosyl isocyanate and other reactive isocyanates, orthoformic esters, calcium oxide or molecular sieves, for example; heat stabilizers, light stabilizers and UV stabilizers; flame retardants; surface-active substances such as, for example, wetting agents, leveling agents, devolatilizers or defoamers; fungicides or substances which inhibit fungal growth; and further substances commonly used in the polyurethane industry.

The polyurethane compositions described are prepared and stored in the absence of moisture. The compositions are stable on storage: that is, they can be kept in a suitable pack or arrangement, such as in a drum, a pouch or a cartridge, for example, for a period of several months up to a year or more prior to their use, without losing their application properties. At the time of application the polyurethane compositions come into contact with moisture, whereupon the polyaldimines B hydrolyze to aldehydes D and polyamines C and the polyamines C react with the isocyanate-group-containing polyurethane prepolymer A and thereby cure it. Either the water required for the reaction can come from the air (atmospheric humidity), or the polyurethane composition can be brought into contact with a water-containing component, such as by being brushed, for example, with such a component, a smoothing agent, for example; by being sprayed; or by means of dipping methods, or else a water-containing component, in the form for example of a water-containing paste, which can be mixed in, for example, via a static mixer, can be added to the polyurethane composition.

If the polyaldimine B is used in a deficit amount, i.e., the chosen ratio of the aldimine groups to the isocyanate groups is substoichiometric, then the excess isocyanate groups react with water that is present.

The reaction of the polyurethane prepolymer A containing isocyanate groups with the hydrolyzing polyaldimine B need not necessarily take place by way of the polyamine C. Also possible, of course, are reactions with intermediates of the hydrolysis of the polyaldimine B to the polyamine C. It is conceivable, for example, for the hydrolyzing polyaldimine B to react directly, in the form of a hemiaminal, with the isocyanate-group-containing polyurethane prepolymer A.

As a consequence of the reactions described above, the polyurethane composition cures.

The polyurethane composition described is distinguished in the cured state by outstanding mechanical properties. It possesses high elongations and high tensile strengths, with moduli of elasticity which can be set in adaptation to the requirements of the respective application by varying the components employed, such as the polyols, polyisocyanates and polyamines, for example, within a wide range.

The aldehydes D which are given off by the polyaldimine B in the course of its hydrolysis are distinguished by the facts that, on account of their high vapor pressure, they remain in the cured polyurethane composition and that they cause no nuisance odor whatsoever. Where long-chain fatty acids are used the effect of the hydrophobic fatty acid residue is to lower the water absorption of the cured polyurethane composition, which increases the resistance of the polyurethane material toward hydrolysis. Moreover, on prolonged water contact, a hydrophobic fatty acid residue affords effective protection against the leaching of the aldehydes D from the cured polyurethane composition. The presence of these aldehydes in the cured polyurethane composition does not cause any impairment in the light stability of the polyurethane material, as is observed when aromatic aldehydes of low volatility are present.

The polyurethane composition described is suitable for use as a sealant of any kind, for the purpose for example of sealing joints in construction, as an adhesive for bonding diverse substrates, such as for bonding components in the production of automobiles, rail vehicles, ships or other industrial goods, for example, and also as a coating or covering for diverse articles and various substrates.

The composition is particularly suitable for odor-sensitive applications, such as the sealing of joints in the interior of buildings and the bonding of components in the interior of vehicles, for example. Preferred coatings are protection coats, sealing systems, protective coatings and primer coatings. Among the coverings, particular preference is given to floor coverings. Coverings of this kind are produced by, typically, pouring a reactive composition onto the substrate and leveling it, where it cures to form a floor covering. Floor coverings of this kind are used, for example, for offices, living areas, hospitals, schools, warehouses, garages and other private or industrial applications. These applications involve large surface areas, which even in the case of applications outdoors can lead to occupational hygiene difficulties and/or odor nuisances. Moreover, a large proportion of floor coverings are applied indoors. Consequently the odor associated with floor coverings is generally a great problem.

The polyurethane composition is at least partly contacted with the surface of an arbitrary substrate. Preference is given to uniform contacting in the form of a sealant or adhesive, a coating or a covering, specifically in those regions which for the purpose of use require a bond in the form of an adhesive bond or seal or else whose substrate is to be covered. It may well be necessary for the substrate and/or the article to be contacted to be subjected, as a preliminary to contacting, to a physical and/or chemical pretreatment, by means for example of abrading, sandblasting, brushing or the like, or by treatment with cleaners, solvents, adhesion promoters, adhesion promoter solutions or primers, or the application of a tie coat or a sealer.

### EXAMPLES

All percentage figures refer, unless indicated otherwise, to percentages by weight.

Polyamines Used:

alpha,omega-Polyoxypropylenediamine (Jeffamine® D-230, Huntsman): total primary amines content≧97%; amine content=8.22 mmol NH₂/g.

1,3-Xylylenediamine (MXDA; Mitsubishi Gas Chemical): MXDA content≧99%; amine content=14.56 mmol NH₂/g.

1,6-Hexamethylenediamine (HDA): HDA content≧99.0%; amine content=17.21 mmol NH₂/g.

1,5-Diamino-2-methylpentane (MPMD; DuPont): MPMD content≧98.5%; amine content=17.11 mmol NH₂/g.

Polyols Used:

Acclaim® 4200 N (Bayer): linear polypropylene oxide polyol with a theoretical OH functionality of 2, average molecular weight about 4000, OH number about 28 mg KOH/g, degree of unsaturation about 0.005 meq/g.

Acclaim® 12200 (Bayer): linear polypropylene oxide polyol with a theoretical OH functionality of 2, average molecular weight about 12 000, OH number about 11 mg KOH/g, degree of unsaturation about 0.005 meq/g.

Caradol® MD34-02 (Shell): nonlinear polypropylene oxide polyethylene oxide polyol, ethylene oxide-terminated, with a theoretical OH functionality of 3, an average molecular weight of about 4900, OH number about 35 mg KOH/g, degree of unsaturation about 0.08 meq/g.

Description of Test Methods:

The viscosity was measured at 20° C. on a cone/plate viscometer from Haake (PK100/VT-500).

The skin-forming time (time to freedom from tack, tack-free time) was determined at 23° C. and 50% relative humidity.

Tensile strength, breaking elongation and elasticity modulus at 0.5%-5% elongation were determined on films cured for 7 days at 23° C. and 50% relative humidity in accordance with DIN EN 53504 (pulling speed: 200 mm/min).

Bubble formation was assessed qualitatively on the basis of the quantity of bubbles which occurred in the course of the curing (at 23° C. and 50% relative humidity) of the films used for the mechanical tests (layer thickness 2 mm).

The odor was assessed on the cast films by smelling with the nose at a distance of 10 cm, first on the composition applied immediately beforehand and a second time 7 days thereafter on the composition cured at 23° C. and 50% relative humidity.

Preparation of Polyurethane Prepolymers

Polyurethane Prepolymer PP1

259 g of polyol Acclaim® 4200 N, 517 g of polyol Caradol® MD34-02, 124 g of 4,4′-methylenediphenyl diisocyanate (MDI; Desmodur® 44 MC L, Bayer) and 100 g of diisodecyl phthalate were reacted by a known method at 80° C. to give an NCO-terminated polyurethane prepolymer. The reaction product had a titrimetrically determined free isocyanate group content of 2.30%, based on the polyurethane prepolymer, and a viscosity at 20° C. of 56 Pa·s.

Polyurethane Prepolymer PP2

845 g of polyol Acclaim® 4200 N and 115 g of 4,4′-methylenediphenyl-diisocyanate (MDI; Desmodur® 44 MC L, Bayer) were reacted by a known method at 80° C. to give an NCO-terminated polyurethane prepolymer. The reaction product had a titrimetrically determined free isocyanate group content of 1.96% and a viscosity at 20° C. of 37 Pa·s.

Polyurethane Prepolymer PP3

937 g of polyol Acclaim® 4200 N, 57 g of tripropylene glycol and 285 g of 4,4′-methylenediphenyl diisocyanate (MDI; Desmodur® 44 MC L, Bayer) were reacted by a known method at 80° C. to give an NCO-terminated polyurethane prepolymer. The reaction product had a titrimetrically determined free isocyanate group content of 3.76% and a viscosity at 20° C. of 58 Pa·s.

Polyurethane Prepolymer PP4

1515 g of polyol Acclaim® 12200 and 82 g of isophorone diisocyanate (IPDI; Vestanat® IPDI, Degussa) were reacted by a known method at 100° C. to give an NCO-terminated polyurethane prepolymer. The reaction product had a titrimetrically determined free isocyanate group content of 0.93% and a viscosity at 20° C. of 45 Pa·s.

Preparation of Polyaldimines

Polyaldimine PA1

A round-bottom flask with reflux condenser and water separator (Dean Stark) was charged with 40.5 g of formaldehyde (37% in water, methanol-free), 36.0 g of isobutyraldehyde, 100.0 g of lauric acid and 1.0 g of 4-toluenesulfonic acid and placed under a nitrogen atmosphere. The mixture was heated in an oil bath with vigorous stirring, whereupon water began to separate. After four hours the bath temperature was raised to 170° C. and the apparatus was evacuated under a water jet vacuum until separation no longer occurred. A total of around 35 ml of distillate collected in the separator. The reaction mixture was cooled and 48.6 g of Jeffamine® D-230 were added from a dropping funnel. Thereafter the volatile constituents were distilled off completely. The reaction product thus obtained, which was liquid at room temperature, had an aldimine content, determined as the amine content, of 2.17 mmol NH₂/g and a viscosity at 20° C. of 700 mPa·s.

Polyaldimine PA2

As described for polyaldimine PA1, 42.8 g of formaldehyde (37% in water, methanol-free), 38.0 g of isobutyraldehyde, 150.0 g of stearic acid and 1.0 g of 4-toluenesulfonic acid were reacted with the separation of around 37 ml of water and the resulting reaction mixture was admixed with 57.0 g of Jeffamine® D-230. Removal of the volatile constituents gave a reaction product with the consistency of cream at room temperature which had an aldimine content, determined as the amine content, of 1.93 mmol NH₂/g.

Polyaldimine PA3

A round-bottom flask with reflux condenser, thermometer and water separator (Dean Stark) was charged with 11.0 g of paraformaldehyde, 40.0 g of 2-methylvaleraldehyde, 64.0 g of lauric acid and 0.5 g of 4-toluenesulfonic acid and placed under a nitrogen atmosphere. The mixture was heated at 100° C. in an oil bath with vigorous stirring until there was a marked reduction in the reflux rate. At that point the reflux cooling was switched off, the bath temperature was raised to 130° C., whereupon water began to separate. After 30 minutes the bath temperature was raised to 170° C. and the apparatus was evacuated under a water jet vacuum for 90 minutes. A total of around 14 ml of distillate collected in the separator. The reaction mixture was subsequently rectified under a high vacuum. To 30.0 g of the resulting aldehyde (2-methyl-2-propyl-3-oxopropyl laurate) were subsequently added 7.6 g of HDA from a dropping funnel. Removal of the volatile constituents at 80° C. under a water jet vacuum gave a colorless reaction product which was liquid at room temperature, was completely odorless and had an aldimine content, determined as the amine content, of 2.72 mmol NH₂/g.

IR: 2955, 2922, 2852, 1737 (C═O), 1667 (C═N), 1466, 1419, 1376, 1343, 1233, 1162, 1112, 1070, 1021, 1008, 939, 885, 863, 740, 722.

Polyaldimine PA4

As described for polyaldimine PA1, 60.2 g of formaldehyde (37% in water, methanol-free), 53.5 g of isobutyraldehyde, 100.0 g of sebacic acid and 1.0 g of 4-toluenesulfonic acid were reacted with the separation of around 52 ml of water. The reaction mixture obtained was cooled, admixed with 19.0 g of n-butanol, stirred for 30 minutes and heated again, whereupon water again began to separate. After one hour the bath temperature was raised to 170° C. and the apparatus was evacuated under a water jet vacuum until separation no longer occurred. A total of around 57 ml (52 ml+5 ml) of distillate collected in the separator. The reaction mixture was cooled and admixed with 72.0 g of Jeffamine® D-230. Removal of the volatile constituents gave a reaction product which was liquid at room temperature and had an aldimine content, determined as the amine content, of 2.49 mmol NH₂/g and a viscosity at 20° C. of 6700 mPa·s.

Polyaldimine PA5

As described for polyaldimine PA1, 40.5 g of formaldehyde (37% in water, methanol-free), 36.0 g of isobutyraldehyde, 100.0 g of lauric acid and 1.0 g of 4-toluenesulfonic acid were reacted with the separation of 35 ml of water and the resulting reaction mixture was admixed with 26.0 g of MXDA. Removal of the volatile constituents gave a reaction product which was liquid at room temperature and had an aldimine content, determined as the amine content, of 2.33 mmol NH₂/g.

Polyaldimine PA6

As described for polyaldimine PA1, 22.3 g of paraformaldehyde, 53.5 g of isobutyraldehyde, 49.5 g of lauric acid, 50.0 g of sebacic acid and 1.0 g of 4-toluenesulfonic acid were reacted with the separation of just under 14 ml of water and the resulting reaction mixture was admixed with 33.0 g of MPMD. Removal of the volatile constituents gave a reaction product which was liquid at room temperature and had an aldimine content, determined as the amine content, of 3.05 mmol NH₂/g and a viscosity at 20° C. of 13 000 mPa·s.

Polyaldimine PA7

A round-bottom flask with thermometer and water separator (Dean Stark) was charged with 51.0 g of 3-hydroxypivalaldehyde (dimeric form), 100.0 g of lauric acid and 1.0 g of 4-toluenesulfonic acid and placed under a nitrogen atmosphere. The mixture was heated in an oil bath with vigorous stirring, whereupon water began to separate. After four hours the bath temperature was raised to 170° C. and the apparatus was evacuated under a water jet vacuum until separation no longer occurred. A total of a good 9 ml of distillate collected in the separator. The reaction mixture was cooled and 48.6 g of Jeffamine® D-230 were added from a dropping funnel. Thereafter the volatile constituents were distilled off completely. The reaction product thus obtained, which was liquid at room temperature, had an aldimine content, determined as the amine content, of 2.19 mmol NH₂/g and a viscosity at 20° C. of 700 mPa·s.

Polyaldimine PA8

A round-bottom flask was charged with 100.0 g of Jeffamine® D-230. With thorough cooling and vigorous stirring, 75.0 g of isobutyraldehyde were added from a dropping funnel. After 12 hours of stirring the volatile constituents were distilled off. The resulting reaction product, liquid at room temperature, had an aldimine content, determined as the amine content, of 5.66 mmol NH₂/g.

Polyaldimine PA9

A round-bottom flask was charged with 62.0 g of Jeffamine® D-230. With thorough cooling and vigorous stirring, 89.5 g of 2,2-dimethyl-3-isobutyroxypropanal were added from a dropping funnel. After 10 minutes of stirring the volatile constituents were distilled off. The resulting reaction product, liquid at room temperature, had an aldimine content, determined as the amine content, of 3.58 mmol NH₂/g.

Polyaldimine PA10

As described for polyaldimine PA9, 45.0 g of MXDA were reacted with 115.0 g of 2,2-dimethyl-3-isobutyroxypropanal. The resulting reaction product, liquid at room temperature, had an aldimine content, determined as the amine content, of 4.43 mmol NH₂/g.

### Examples 1-4 (Inventive) and Examples 5-7 (Comparative)

The polyurethane prepolymers and polyaldimines indicated in table 1 were mixed homogeneously in an NH₂/NCO ratio (i.e., equivalents of aldimine groups per equivalents of isocyanate groups of the polyurethane prepolymer) of 0.5/1.0. Benzoic acid (200 mg/100 g of polyurethane prepolymer) was added to the mixture, homogeneous mixing was repeated and the resulting mixtures were immediately dispensed into airtight tubes which were stored at 60° C. for 15 hours. Then a portion of the mixture was poured into a metal sheet coated with PTFE (film thickness about 2 mm) and cured for 7 days at 23° C. and 50% relative humidity, after which the mechanical properties of the through-cured film were measured. The remaining contents of the tube were used to determine the storage stability, by measuring the viscosity before and after storage at 60° C. for 7 days. The results of the tests are set out in table 1.

TABLE 1

| | Example | | | | | | |
|---|---|---|---|---|---|---|---|
| | 1 | 2 | 3 | 4 | 5 Ref.* | 6 Ref.* | 7 Ref.* |
| Polyurethane prepolymer | PP1 | PP1 | PP1 | PP1 | PP1 | PP1 | PP1 |
| Polyaldimine | PA1 | PA2 | PA3 | PA4 | PA8 | PA9 | — |
| Viscosity before storage | 50 | 66 | 55 | 70 | 120 | 48 | 56 |
| (Pa · s) | | | | | | | |
| Viscosity after storage | 59 | 79 | 58 | 81 | — | 58 | 61 |
| (Pa · s) | | | | | (gelled) | | |
| Skin-forming time (min) | 35 | 38 | 32 | 45 | 25 | 29 | >600 |
| Bubble formation | none | none | none | none | none | none | very severe |
| Tensile strength (MPa) | 1.3 | 1.2 | 2.0 | 1.1 | 1.2 | 1.2 | n.m. |
| Breaking elongation (%) | 150 | 160 | 160 | 130 | 140 | 150 | n.m. |
| Elasticity modulus | 1.7 | 1.5 | 9.0 | 1.7 | 2.1 | 2.0 | n.m. |
| 0.5-5% (MPa) | | | | | | | |
| Odor on application | none | none | none | none | very strong | strong | none |
| Odor after 7 days | none | none | none | none | slight | strong | none |

(n.m. = not measurable)
*Ref. = comparative

The results show that the compositions of the invention of examples 1-4 are stable on storage, exhibit good reactivity (skin-forming time) and cure without bubbles. They do not give off any nuisance odor, either on application or later, and in the cured state possess good mechanical properties. The comparative example 5, formulated in accordance with the prior art, is not stable on storage and has a strong odor. The comparative example 6, formulated in accordance with U.S. Pat. No. 4,469,831, is equal in respect of storage stability, reactivity, bubble formation and mechanical properties to examples 1-4; even in the course of curing, however, and for a long time afterward as well, it gives off a clearly perceptible, nuisance odor. Comparative example 7, finally, formulated entirely without polyaldimine, is indeed odorless but displays an inadequate reactivity (slow skin-forming time) and a strong tendency to form bubbles.

### Examples 8-9 (Inventive) and Example 10 (Comparative)

As described in example 1, compositions were prepared from different polyurethane prepolymers and polyaldimines and tested (NH₂/NCO ratio used=0.7/1.0).

The polyurethane prepolymers and polyaldimines used and the results of the tests are set out in table 2.

TABLE 2

| | Example | | |
|---|---|---|---|
| | | | 10 |
| | 8 | 9 | comparative |
| Polyurethane prepolymer | PP2 | PP2 | PP2 |
| Polyaldimine | PA5 | PA6 | PA10 |
| Viscosity before storage (Pa · s) | 32 | 36 | 34 |
| Viscosity after storage (Pa · s) | 37 | 43 | 38 |
| Skin-forming time (min) | 40 | 50 | 40 |
| Bubble formation | none | none | none |
| Tensile strength (MPa) | 9.1 | 3.0* | 7.5 |
| Breaking elongation (%) | 1300 | >1300 | 1300 |
| Elasticity modulus 0.5-5% (MPa) | 3.6 | 0.8 | 4.5 |
| Odor on application | none | none | strong |
| Odor after 7 days | none | none | strong |

*value at max. elongation (1300%)

The results show that the compositions of the invention of examples 8-9 are stable on storage, have good reactivity (skin-forming time) and cure without bubbles. They do not give off a nuisance odor, either during application or later, and in the cured state possess good mechanical properties. The latter depend greatly on the polyaldimine used (or on its parent polyamine), as clearly shown by the differences between the two examples. Comparative example 10, formulated in accordance with U.S. Pat. No. 4,469,831, is equal in respect of storage stability, reactivity, bubble formation and mechanical properties; however, even during curing and also for a long time thereafter, it gives off a clearly perceptible, nuisance odor.

### Examples 11-12 (Inventive) and Example 13 (Comparative)

As described in example 1, compositions were prepared from different polyurethane prepolymers and polyaldimines and tested (NH₂/NCO ratio used=0.5/1.0).

TABLE 3

| | Example | | |
|---|---|---|---|
| | | | 13 |
| | 11 | 12 | comparative |
| Polyurethane prepolymer | PP3 | PP3 | PP3 |
| Polyaldimine | PA7 | PA5 | PA9 |
| Viscosity before storage (Pa · s) | 31 | 38 | 40 |
| Viscosity after storage (Pa · s) | 37 | 44 | 44 |
| Skin-forming time (min) | 100 | 85 | 80 |
| Bubble formation | none | none | none |
| Tensile strength (MPa) | 6.2 | 7.6 | 7.5 |
| Breaking elongation (%) | 860 | 900 | 700 |
| Elasticity modulus 0.5-5% (MPa) | 1.7 | 5.0 | 2.4 |
| Odor on application | none | none | strong |
| Odor after 7 days | none | none | strong |

The polyurethane prepolymers and polyaldimines used and also the results of the tests are set out in table 3.

The results show that the compositions of the invention of examples 11-12 are stable on storage, exhibit good reactivity (skin-forming time) and cure without bubbles. They do not give off a nuisance odor, either during application or later, and in the cured state possess good mechanical properties. The latter vary with the polyaldimine used (or with its parent polyamine), which is clear from a comparison of the test figures for the two examples. Comparative example 13, formulated in accordance with U.S. Pat. No. 4,469,831, is equal in respect of storage stability, reactivity, bubble formation and mechanical properties; however, even during curing and also for a long time thereafter, it gives off a clearly perceptible, nuisance odor.

### Example 14 (Inventive) and Example 15 (Comparative)

As described in example 1, compositions were prepared from different polyurethane prepolymers and polyaldimines and tested (NH₂/NCO ratio used=0.9/1.0). The polyurethane prepolymers and polyaldimines used and also the results of the tests are set out in table 4.

TABLE 4

Example

| | | 15 |
|---|---|---|
| | 14 | comparative |
| Polyurethane prepolymer | PP4 | PP4 |
| Polyaldimine | PA4 | PA10 |
| Viscosity before storage (Pa · s) | 37 | 38 |
| Viscosity after storage (Pa · s) | 42 | 41 |
| Skin-forming time (min) | 240 | 220 |
| Bubble formation | none | none |
| Odor after application | none | strong |
| Odor after 7 days | none | strong |

The results show that the composition of example 14 of the invention is stable on storage, has good reactivity (skin-forming time) and cures without bubbles. Neither during application nor later on does it give off a nuisance odor. Comparative example 15, formulated in accordance with U.S. Pat. No. 4,469,831, is equal in respect of storage stability, reactivity and bubble formation; however, during and after curing, it gives off a clearly perceptible, nuisance odor.

1. A composition comprising
at least one polyurethane prepolymer A having isocyanate end groups, prepared from at least one polyisocyanate and at least one polyol; and
at least one polyaldimine B which is obtainable from
at least one polyamine C having aliphatic primary amino groups and
at least one aldehyde D of the formula 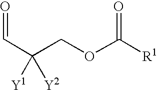
where Y¹ and Y² either
independently of one another are an alkyl, aryl or arylalkyl group which if desired can in each case be substituted, if desired can in each case contain heteroatoms and if desired can in each case contain unsaturated components,
or Y¹ and Y²
are connected to one another to form a carbocyclic or heterocyclic ring which has a ring size of between 5 and 8, preferably 6, atoms and if desired has one or two singly unsaturated bonds; and
R¹ stands either
for a linear or branched alkyl chain having 11 to 30 carbon atoms, if desired having at least one heteroatom, in particular having at least one ether oxygen, or for a singly or multiply unsaturated linear or branched hydrocarbon chain having 11 to 30 carbon atoms; 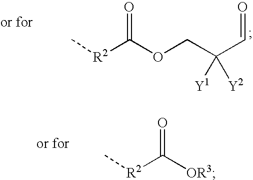
where R² stands for a linear or branched or cyclic alkylene chain having 2 to 16 carbon atoms, if desired having at least one heteroatom, in particular having at least one ether oxygen, or for a singly or multiply unsaturated linear or branched or cyclic hydrocarbon chain having 2 to 16 carbon atoms,
R³ is a linear or branched alkyl chain having 1 to 8 carbon atoms.

2. The composition as claimed in claim 1, characterized in that the polyurethane prepolymer A has a free isocyanate group content of 0.1% to 15% by weight, preferably 0.5%-5% by weight, based on the polyurethane prepolymer as a whole.

3. The composition as claimed in claim 1, characterized in that the polyisocyanate for preparing the polyurethane prepolymer A is a diisocyanate, in particular selected from the group consisting of MDI, TDI, HDI and IPDI.

4. The composition as claimed in claim 1, characterized in that the polyol for preparing the polyurethane prepolymer A has an average OH functionality of 1.6 to 3.

5. The composition as claimed in claim 4, characterized in that the polyol is a polyoxyalkylene polyol, in particular having a degree of unsaturation <0.02 meq/g and a molecular weight Mₙ of 1000-30 000 g/mol.

6. The composition as claimed in claim 5, characterized in that the polyol is a polyol prepared by means of DMC catalysis.

7. The composition as claimed in claim 4, characterized in that the polyol is a polyoxyalkylene polyol, in particular having a molecular weight Mₙ of 400-8000 g/mol.

8. The composition as claimed in claim 4, characterized in that the polyol is a polyoxypropylene polyol or an EO-endcapped polyoxypropylene polyol.

9. The composition as claimed in claim 1, characterized in that for preparing the polyaldimine B the aldehyde D is used stoichiometrically or in a stoichiometric excess in relation to the primary amino groups of the polyamine C.

10. The composition as claimed in claim 1, characterized in that the polyurethane prepolymer A and the polyaldimine B are present in a ratio of 0.1-1.1 equivalent of aldimine groups per equivalent of isocyanate groups.

11. The composition as claimed in claim 1, characterized in that the polyamine C having aliphatic primary amino groups is selected from the group consisting of 1,6-hexamethylenediamine, MPMD, DAMP, 2,2,4- and 2,4,4-trimethylhexamethylenediamine, 4-aminomethyl-1,8-octanediamine, IPDA, 1,3- and 1,4-xylylenediamine, 1,3- and 1,4-bis(aminomethyl)cyclohexane, bis(4-aminocyclohexyl)methane, bis(4-amino-3-methylcyclohexyl)methane, 3(4),8(9)-bis-(aminomethyl)tricyclo[5.2.1.0^{2,6}]decane, 1,2-, 1,3- and 1,4-diaminocyclohexane, poly-oxyalkylene-polyamines having in theory two or three amino groups, especially Jeffamine® EDR-148, Jeffamine® D-230, Jeffamine® D-400 and Jeffamine® T-403, and, in particular, mixtures of two or more of the aforementioned polyamines.

12. The composition as claimed in claim 1, characterized in that the aldehyde D used for preparing the polyaldimine B is obtainable by means of an esterification reaction of a β-hydroxy aldehyde with a carboxylic acid, in particular without the use of a solvent, the β-hydroxy aldehyde being prepared, if desired in situ, from formaldehyde, and/or paraformaldehyde or an oligomeric form of formaldehyde, and from a second aldehyde, this second aldehyde being selected from the group consisting of isobutyraldehyde, 2-methylbutyraldehyde, 2-ethylbutyraldehyde, 2-methylvaleraldehyde, 2-ethylcaproaldehyde, cyclopentane-carboxaldehyde, cyclohexanecarboxaldehyde, 1,2,3,6-tetrahydrobenzaldehyde, 2-methyl-3-phenylpropionaldehyde, 2-phenylpropionaldehyde and diphenylacetaldehyde, preferably isobutyraldehyde.

13. The composition as claimed in claim 1, characterized in that the aldehyde D used for preparing the polyaldimine B is obtainable by means of an esterification reaction of 3-hydroxypivalaldehyde, which is prepared if desired in situ from formaldehyde, and/or paraformaldehyde, and isobutyraldehyde, with a carboxylic acid, in particular without the use of a solvent.

14. The composition as claimed in claim 13, characterized in that the carboxylic acid used for preparing the aldehyde D is selected from the group consisting of lauric acid, myristic acid, palmitic acid, stearic acid, oleic acid, linoleic acid, linolenic acid, succinic acid, adipic acid, azelaic acid and sebacic acid.

15. The composition as claimed in claim 1, characterized in that Y¹=Y²=methyl.

16. A process for preparing the composition as claimed in claim 1, comprising a step of preparing a polyaldimine by reacting an aldehyde with an amine.

17. The process for preparing the composition, as claimed in claim 16, further comprising a step of preparing an aldehyde D from a carboxylic acid and a β-hydroxy aldehyde, in particular without the use of a solvent, the β-hydroxy aldehyde being prepared, if desired in situ, from formaldehyde, and/or paraformaldehyde or an oligomeric form of formaldehyde, and from a second aldehyde.

18. The process for preparing the composition, as claimed in claim 16, further comprising a step of preparing an aldehyde D from a carboxylic acid and 3-hydroxypivalaldehyde and isobutyraldehyde, in particular without the use of a solvent, 3-hydroxypivalaldehyde being prepared, if desired in situ, from formaldehyde, and/or paraformaldehyde.

19. The use of the composition as claimed in claim 1 as an adhesive, sealant, coating or covering.

20. An arrangement characterized in that it comprises a composition as claimed in claim 1.

21. An article whose surface has been at least partly contacted with a composition as claimed in claim 1.

22. A method of adhesive bonding, characterized in that it comprises a step of contacting with a composition as claimed in claim 1.

23. A method of sealing, characterized in that it comprises a step of contacting with a composition as claimed in claim 1.

24. A method of coating, characterized in that it comprises a step of contacting with a composition as claimed in claim 1.

25. The method as claimed in claim 22, characterized in that it comprises an additional step of curing in air.

26. The method as claimed in claim 22, characterized in that it further comprises a step of contacting with a water-containing component or an admixture thereof.
